(19) United States
(12) Patent Application Publication
(10) Pub. No.: US 2007/0023264 A1
(43) Pub. Date: Feb. 1, 2007

(54) ROLLER STRUCTURE AND ELECTRONIC DEVICE USING THE SAME

(75) Inventor: Xian-Jun Wang, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/459,777

(22) Filed: Jul. 25, 2006

(30) Foreign Application Priority Data
Jul. 29, 2005 (TW) 94125922

(51) Int. Cl. H01H 3/16

(52) U.S. Cl. 200/61.7

(57) ABSTRACT

A roller structure and an electronic device using the same are provided. The roller structure includes a bearing element, an axis element, a sliding element and a seal element. The bearing element has a fillister and a passage. The axis element is rotatably plugged into the fillister and has a recess. The seal element is connected to the bearing element for forming the passage inside the bearing element and sealing the passage. When the electronic device is at an operating status, the sliding element is slidden into the passage so that the cover rotates with respect to the body. When the electronic device is at another operating status and the surface of the cover forms an angle with the surface of the body opposite to the cover, the sliding element is partly positioned between the recess and the passage for limiting the roll range of the axis element.

This application claims the benefit of Taiwan application Serial No. 94125922, filed on Jul. 29, 2005, the subject matter of which is incorporated herein by reference.

### BACKGROUND OF THE INVENTION

1. Field of the Invention

The invention relates in general to a roller structure and an electronic device using the same, and more particularly to a roller structure having more than two operating statuses and an electronic device using the same.

2. Description of the Related Art

Along with the advance and development in technology, the integration and application of multi-media products have become a trend. The so called “multi-media” refers to the data content composed of texts, images, voices and other data types. In terms of image processing, scanners, facsimile machines, multi-function peripherals are the most commonly used tools for capturing images.

Scanner has become an indispensable item of peripheral equipment to both individual and enterprise users. Scanner is an image capturing device for scanning and converting photos, text pages, pictures and inserts into the digital formats that a computer can display, edit, output and store. Scanner can do many jobs such as incorporating a document with a drawing or a picture, scanning and outputting texts into a word processing software directly without retyping the texts, scanning and outputting a facsimile document to a database or a word processing software, adding interesting and lively images to a multi-media work, or integrating images and information so that the main theme can be conveyed more effectively in a presentation.

For the convenience of operation, flat type scanner, vertical type scanner and suspension type scanner are provided. Conventional scanner includes a body and a cover. The cover can be opened from the body so that the to-be-scanned document can be loaded. After the cover is closed, the to-be-scanned document is spread over the body. In a conventional scanner, the cover and the body are not limited by the roller and can rotate freely under whatever operating statuses. When the scanner adopts flat type scanning and the body of the scanner is placed on a desk, the cover can be opened or closed freely until the cover reaches the desk top and halts. When the scanner adopts vertical type scanning and the body is placed on the desk and tilts to one side, the cover can be opened or closed freely until the cover reaches the desk top and halts. When the scanner adopts suspension type scanning and the body is mounted on the wall, the cover can be opened or closed freely until the cover reaches the wall top and halts.

When the conventional scanner adopt vertical type scanning and suspension type scanning, the cover will closed a large angle with the body when the cover is opened from or closed to the body, cause great impact to the roller Moreover, in the course of operation, when the cover is opened from or closed to the body at too large an angle, the user may easily hit the cover, causing damage to the roller and largely shortening the lifespan of the roller.

### SUMMARY OF THE INVENTION

It is therefore an object of the invention to provide a roller structure and an electronic device using the same. By incorporating the sliding element, the passage and the recess, the electronic device enables the cover to be closed to and opened from the body to a range of angles under different operating statuses, not only reducing the impact on the roller structure but also extending the lifespan of the roller structure.

The invention achieves the above-identified object by providing a roller structure disposed in an electronic device. The electronic device at least includes a cover and a body. The electronic device at least has a first operating status and a second operating status. The first operating status is an operating status when the body is placed on a horizontal surface. The second operating status is an operating status when the surface of the body forms a first angle with the horizontal surface. The roller structure includes a bearing element, an axis element, a sliding element and a seal element.

The bearing element is projected from the body, and has a fillister and a passage. The axis element is projected from the cover, and is rotatably plugged into the fillister of the bearing element. The axis element has a recess disposed on the surface of the axis element. The sliding element is capable of sliding reciprocally between the passage and the recess. The seal element is connected to the bearing element for forming the passage inside the bearing element and sealing the passage. When the electronic device is at the first operating status, the sliding element is completely slidden into the passage, so that the cover can rotate with respect to the body. When the electronic device is at second operating status and when the surface of the cover forms a second angle with the surface of the body opposite to the cover, the passage and the recess are connected, and the sliding element is partly slidden into the recess and partly positioned inside the passage for limiting the roll range of the axis element.

The invention further achieves the above-identified object by providing an electronic device, The electronic device at least has a first operating status and a second operating status. The electronic device includes a body, a cover and a roller structure. The first operating status is an operating status when the body is placed on a horizontal surface. The second operating status is an operating status when the surface of the body forms a first angle with the horizontal surface. The cover is rotatably connected to the body. The roller structure includes a bearing element, an axis element, a sliding element and a seal element. The bearing element is projected from the body, and has a fillister and a passage. The axis element is projected from the cover, and is rotatably plugged into the fillister of the bearing element. The axis element has a recess disposed on the surface of the axis element. The sliding element is capable of sliding reciprocally between the passage and the recess The seal element is connected to the bearing element for forming the passage inside the bearing element and sealing the passage. When the electronic device is at the first operating status, the sliding element is completely slidden into the passage, so that the cover can rotate with respect to the body. When the electronic device is at the second operating status and the surface of the cover forms a second angle with the surface of the body opposite to the cover, the passage and the recess are connected, and the sliding element is partly slidden into the recess and partly positioned inside the passage for limiting the roll range of the axis element.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded diagram of a body, a cover and a roller structure according to a first embodiment of the invention;

FIG. 2 is an enlarged diagram of the roller structure of FIG. 1;

FIG. 3 is a diagram illustrating the electronic device according first embodiment of the invention is at a first operating status;

FIG. 4 is a diagram illustrating the electronic device of FIG. 3 with an opened cover;

FIG. 5 is a diagram illustrating the electronic device according to the first embodiment of the invention is at a second operating status;

FIG. 6 is a diagram illustrating the electronic device of FIG. 5 with a second angle being contained between the surface of the cover and the surface opposite to the cover;

FIG. 7 is a diagram illustrating the electronic device according to the first embodiment of the invention is at a third operating status;

FIG. 8 is a diagram illustrating the electronic device of FIG. 7 with a second angle being contained between the surface of the cover and the surface opposite to the cover;

FIG. 9 is an exploded diagram of a body, a cover and a roller structure according to a second embodiment of the invention; and

FIG. 10 illustrates an assembly diagram of the body, the cover and the roller structure of FIG. 9.

### DETAILED DESCRIPTION OF THE INVENTION

First Embodiment

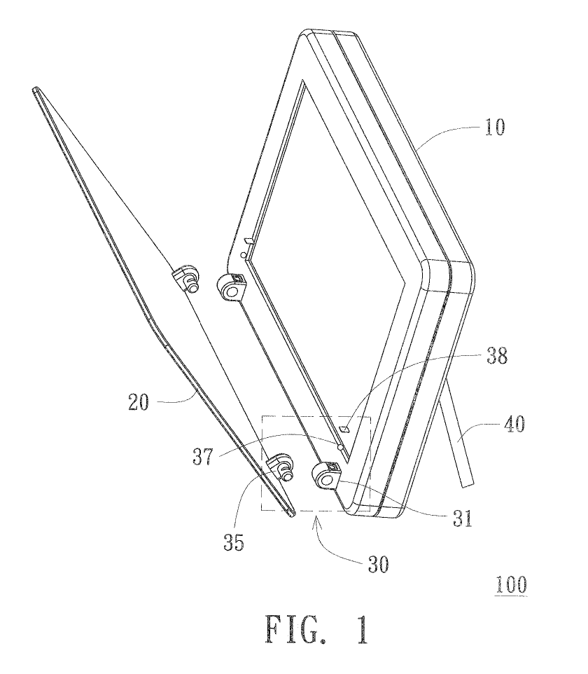

Referring to FIG. 1, an exploded diagram of a body, a cover and a roller structure according to a first embodiment of the invention is shown. Examples of the electronic device using the roller structure include a scanner, a facsimile machine, a printer or a multi-function peripheral. In the present embodiment of the invention, the electronic device 100 is exemplified by a scanner. The electronic device 100 includes a body 10, a cover 20 and a roller structure 30. The to-be-scanned document is placed on the body 10. The cover 20 is rotatably opened from or closed to the body 10 via the roller structure 30. The roller structure 30 includes a bearing element 31, an axis element 35, a sliding element 37 and a seal element 38.

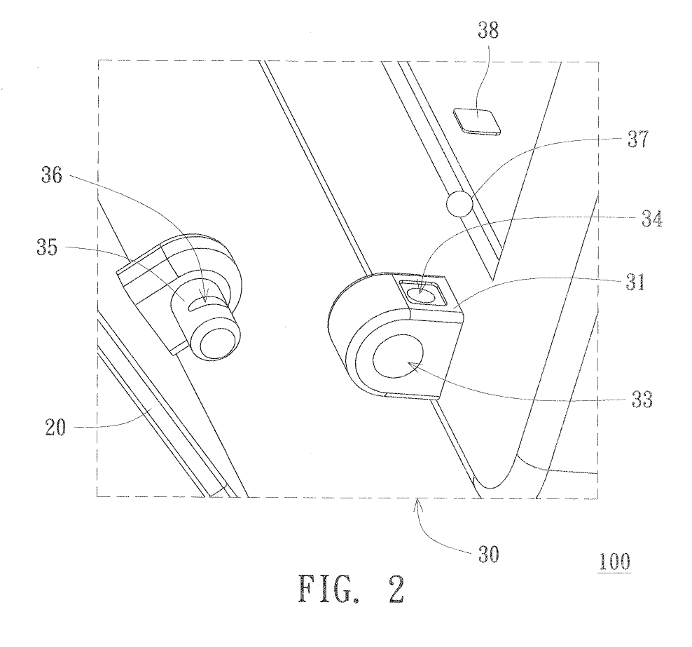

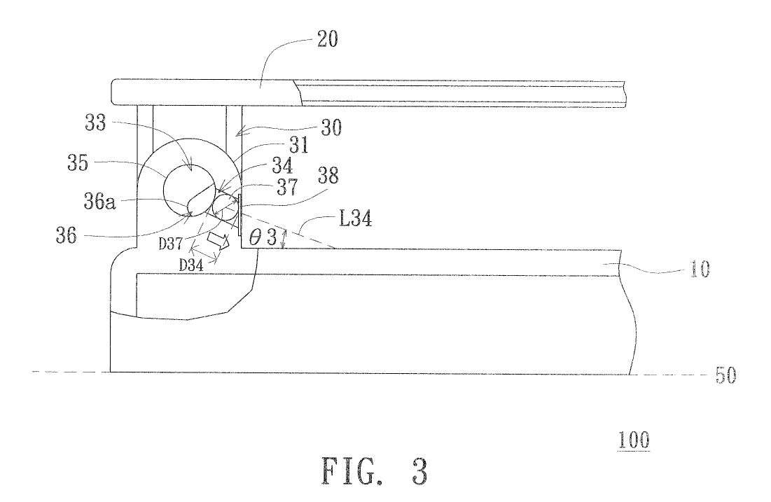

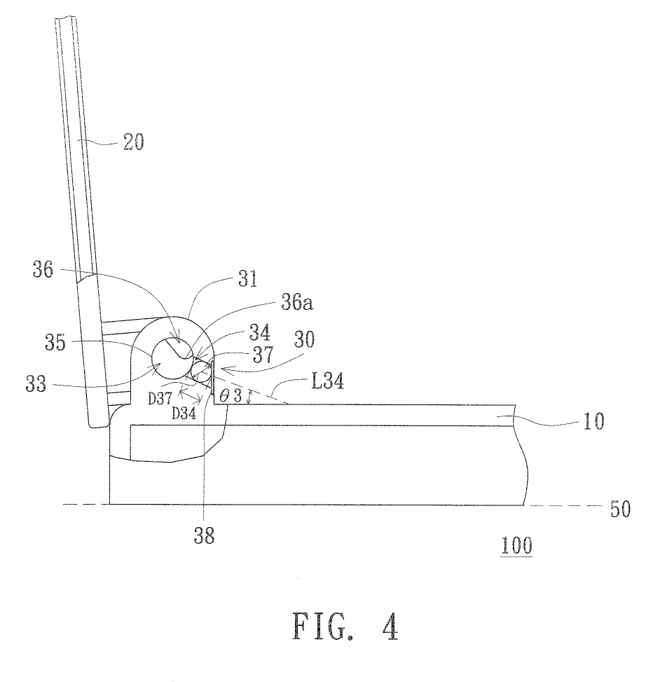

Referring to FIG. 2, an enlarged diagram of the roller structure of FIG. 1 is shown. The bearing element 31 includes a fillister 33 and a passage 34. The fillister 33 is disposed in the bearing element 31. One end of the passage 34 is connected to the fillister 33, while the other end of the passage 34 is sealed inside the bearing element 31 by the seal element 38. In the present embodiment of the invention, the seal element 38 is exemplified by a pad. The axis element 35 is projected from the cover 20 20 and is rotatably plugged into the fillister 33 of the bearing element 31. The axis element 35 has a recess 36 disposed on the axis element 35. The recess 36 is able to be connected to the passage 34 during part of the roll range of the axis element 35. The sliding element 37 is a globe and is slideably plugged into the passage 34, the electronic device according to the first embodiment of the invention is at a first operating status. FIG. 4 is a diagram illustrating the electronic device of FIG. 3 with an opened cover. T he electronic device is at a first operating status, that is, an operating status when the body 10 is placed horizontally. As shown in FIG. 3 and FIG. 4, no matter the cover 20 is rotated to whatever position along with the axis element 35, the sliding element 37 does not affect the rotation of the axis element 35 at all. The passage 34 has a central axis L34. The central axis L34 forms a third angle θ3 with the surface of the body 10. Since the third angle θ3 is larger than 0 degree, the electronic device 100 is at the first operating status, and the sliding element 37 naturally slides to the end of the passage 34 close to the seal element 38. The length D34 of the passage 34 is not smaller than the diameter D37 of the sliding element 37, so that the sliding element 37 can be completely received in the passage 34. Therefore, the sliding element 37 does not affect the rotation of the axis element 35, and the cover 20 can rotate freely until the cover 20 reaches the body 10, the horizontal surface 50 or other components.

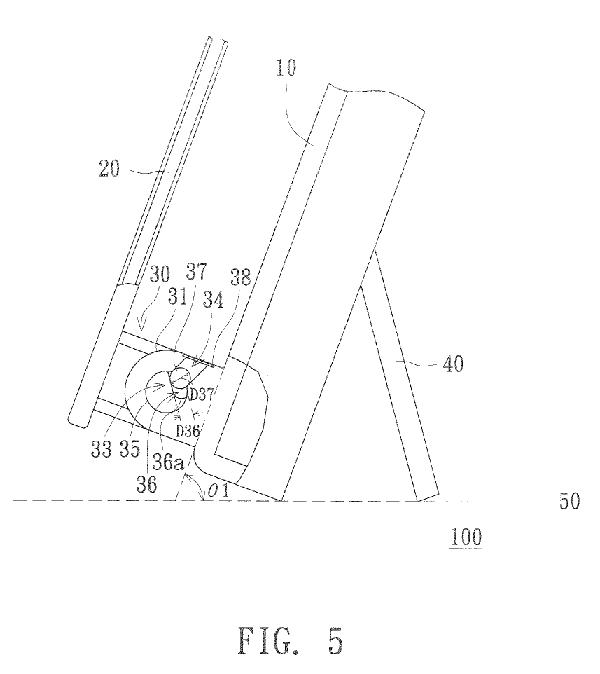

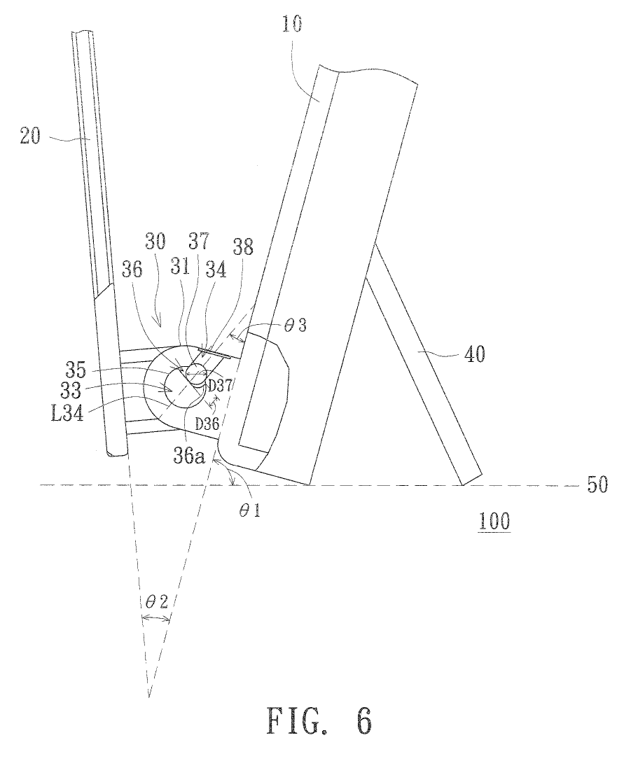

Referring to both FIG. 5 and FIG. 6, FIG. 5 is a diagram illustrating the electronic device according to the first embodiment of the invention is at a second operating status. FIG. 6 is a diagram illustrating the electronic device of FIG. 5 with a second angle being contained between the surface of the cover and the surface opposite to the cover. The electronic device 100 is at a second operating status, that is, an operating status when the body 10 forms a first angle θ1 with the horizontal surface 50. The electronic device 100 is supported by a carriage 40. As shown in FIG. 5 and FIG. 6, when the cover 20 rotates until the cover 20 forms a second angle θ2 with the body 10, the sliding element 37 will halt the rotation of the axis element 35. Preferably, the second angle θ2 ranges between 30 degrees and 60 degrees. Since the third angle θ3 is smaller than the first angle θ1, the electronic device 100 is at the second operating status, and the sliding element 37 naturally slides to the end of the passage 34 close to the fillister 33. When the surface of the cover 20 forms the second angle θ2 with the surface of the body 10 opposite to the cover 20, the recess 36 is connected to the passage 34, the sliding element 37 is slidden into the recess 36 by gravity. The depth D36 of the recess 36 ranges between a half to one time of the diameter D37 of the sliding element 37. Therefore, when the sliding element 37 is slidden into the recess 36, one part of the sliding element 37 is received in the recess 36 while the other part of the sliding element 37 is received in the passage 34. The sliding element 37 presses a sidewall 36a of the recess, so that the rotation of axis element 35 is halted by the sliding element 37. Meanwhile, the angle of rotation between the surface of the cover 20 and the surface opposite to the cover 20 is limited to be within the second angle θ2.

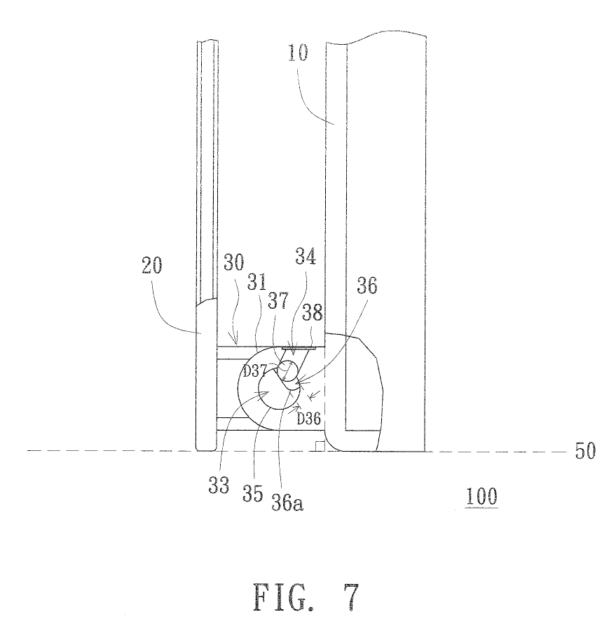

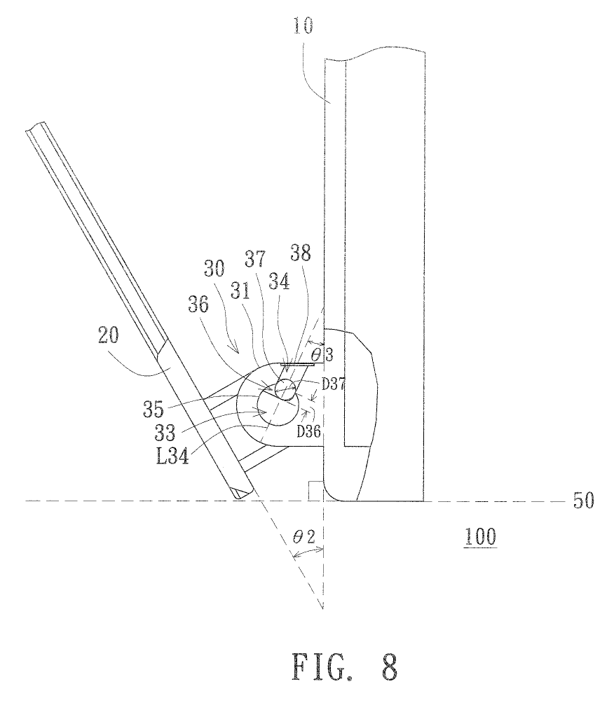

Referring to both FIG. 7 and FIG. 8. FIG.7 is a diagram illustrating the electronic device according to the first embodiment of the invention is at a third operating status. FIG. 8 is a diagram illustrating the electronic device of FIG.7 with a second angle being contained between the surface of the cover and the surface opposite to the cover. The electronic device 100 is at a third operating status, that is, an operating status when the surface of the body 10 forms an angle of 90 degrees with the horizontal surface 50. When the electronic device 100 is at the third operating status, the theory and operation of the electronic device 100 are the same with the theory and operation of the electronic device at the second operating status with the first angle θ1 reaching 90 degrees, and are not repeated here. As shown in FIG. 7 and FIG. 8, when the cover 20 rotates until the angle between the cover 20 and the body 10 reaches the second angle θ2, the sliding element 37 will halt the rotation of the axis element 35. Meanwhile, the angle of rotation between the surface of the cover 20 and the surface opposite to the cover 20 is limited to be within the second angle θ2.

In the electronic device 100 of the invention, the sliding element 37 is exemplified a sphere. However anyone who is skilled in the technology of the present embodiment of the invention will understand that the scope of technology of the present embodiment of the invention is not limited thereto. For example, the sliding element 37 of the invention can be a cylinder or an ellipsoid. Any design that enables the sliding element 37 to slide reciprocally inside the passage 34 and effectively halt the rotation of the axis element 35 when the sliding element 37 slides to the edge 36a of the recess 36 is within the scope of protection of the invention.

Second Embodiment

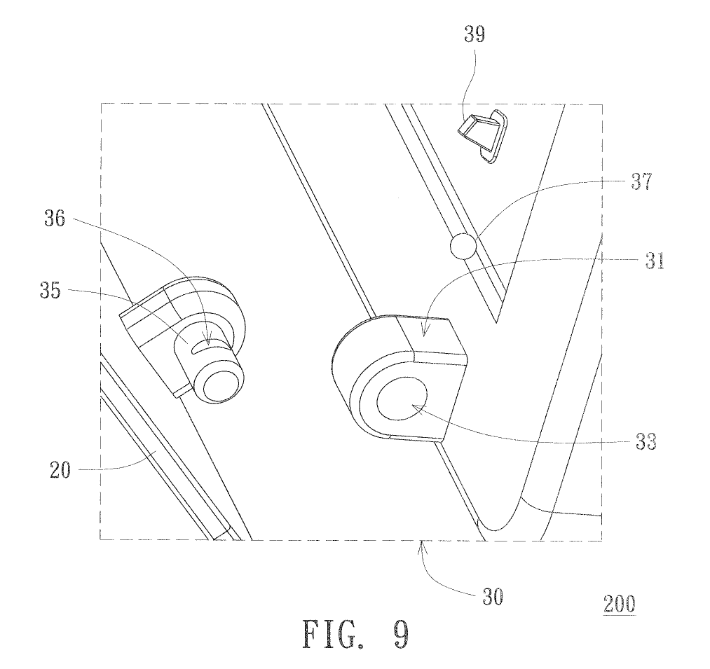

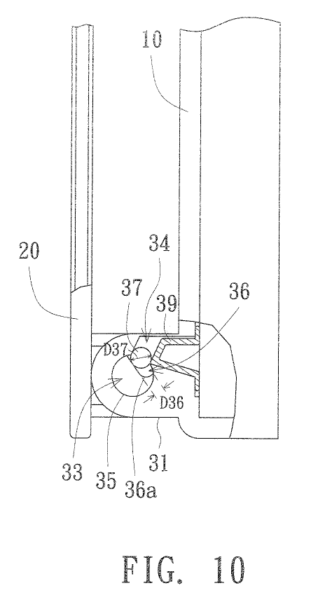

Referring to both FIG, 9 and FIG. 10. FIG. 9 is an exploded diagram of a body, a cover and a roller structure according to a second embodiment of the invention. FIG. 10 illustrates an assembly diagram of the body, the cover and the roller structure of FIG. 9 The electronic device 200 of the present embodiment of the invention differs with the electronic device 100 of the first embodiment in the seal element 39. As for other similar components, the same reference numbers are used and are not repeated here. In the present embodiment of the invention, the seal element 39 is a bump, and is plugged into the bearing element 31 for forming a passage 34 with the inner wall of the bearing element 31. The seal element 39 is disposed inside the bearing element 31 so that the outer appearance of the bearing element 31 remains intact. The theory and operation of the roller structure 30 are the same with theory and operation of the roller structure of the first embodiment, and are not repeated here.

The roller structure and the electronic device using the same disclosed in the above embodiments of the invention incorporate the sliding element, the passage and the recess, so that the electronic device enables the cover to be closed to and opened from the body to a range of angles under different operating statuses, not only reducing the impact on the roller structure but also extending the lifespan of the roller structure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A roller structure disposed in an electronic device, wherein the electronic device at least comprises a cover and a body, the body is placed on a horizontal surface when the electronic device is at a first operating status, the surface of the body forms a first angle with the horizontal surface when the electronic device is at a second operating status, and the roller structure comprises:
a bearing element projected from the body, wherein the bearing element has a fillister and a passage;
an axis element projected from the cover and rotatably plugged into the fillister, wherein the axis element has a recess disposed on the surface of the axis element;
a sliding element for reciprocally sliding between the passage and the recess; and
a seal element connected to the bearing element for forming the passage inside the bearing element and sealing the passage;
wherein when the electronic device is at the first operating status, the sliding element is slidden into the passage, so that the cover can rotate with respect to the body;
wherein when the electronic device is at the second operating status and when the surface of the cover forms a second angle with the surface of the body opposite to the cover, the passage and the recess are connected, and the sliding element is partly slidden into the recess and partly positioned inside the passage for limiting the range of the axis element.

2. The roller structure according to claim 1, wherein the seal element is a pad.

3. The roller structure according to claim 1, wherein the seal element is a bump.

4. The roller structure according to claim 1, wherein a central axis of the passage forms a third angle with the surface of the body, and when the electronic device is at the first operating status, the sliding element is slidden into the passage, so that the cover can rotate with respect to the body.

5. The roller structure according to claim 4, wherein when the electronic device is at the second operating status, the third angle is smaller than the first angle.

6. The roller structure according to claim 1, wherein the first angle can be 90 degrees or a specific angle smaller than 90 degrees.

7. The roller structure according to claim 1, wherein the sliding element is a spherical object, the recess has a depth smaller than the diameter of the sliding element, but larger than the radius of the sliding element, and the passage has a length larger than the diameter of the sliding element.

8. An electronic device, comprising:
body placed on a horizontal surface when the electronic device is at a first operating status, wherein the surface of the body forms a first angle with the horizontal surface when the electronic device is at a second operating status;
a cover rotatably connected to the body; and
a roller structure, comprising:
a bearing element projected from the body, wherein the bearing element has a fillister and a passage;
an axis element projected from the cover and rotatably plugged into the fillister, wherein the axis element has a recess disposed on the surface of the axis element;
a sliding element for reciprocally sliding between the passage and the recess; and
a seal element connected to the bearing element for forming the passage inside the bearing element and sealing the passage;
wherein when the electronic device is at the first operating status, the sliding element is completely slidden into the passage, so that the cover can rotate with respect to the body;
wherein when the electronic device is at the second operating status and the surface of the cover forms a second angle with the surface of the body opposite to the cover, the passage and the recess are connected, and the sliding element is partly sided into the recess and partly positioned the passage for limiting the roll range of the axis element.

9. The electronic device according to claim 8, wherein the seal element is a pad.

10. The electronic device according to claim 8, wherein the seal element is a bump.

11. The electronic device according to claim 8, wherein the first angle can be 90 degrees or a specific angle smaller than 90 degrees, and the electronic device further has a third operating status when the first angle is 90 degrees.

12. The electronic device according to claim 8, wherein a central axis of the passage forms a third angle with the surface of the body, when the electronic device is at the first operating status, the sliding element is slidden into the passage, so that the cover can rotate with respect to the body.

13. The electronic device according to claim 12, wherein when the electronic device is at the second operating status, the third angle is smaller than the first angle.

14. The electronic device according to claim 12, wherein when the electronic device is at the third operating status, the third angle is smaller than the first angle.

15. The electronic device according to claim 8, wherein the sliding element is a spherical object, the recess has a depth smaller than the diameter of the sliding element but larger than the radius of the sliding element, and the passage has a length larger than the diameter of the sliding element.

16. The electronic device according to claim 8, being a scanner, a facsimile machine, a printer or a multi-function peripheral.
